(19) United States
(12) Patent Application Publication
(10) Pub. No.: US 2025/0112006 A1
(43) Pub. Date: Apr. 3, 2025

(54) DEVICE INCLUDING A BUTTON ATTACHED TO A HAPTIC ENGINE

(71) Applicant: Apple Inc., Cupertino, CA (US)

(72) Inventors: Darya Amin-Shahidi, Menlo Park, CA (US); Stephanie Moon, San Francisco, CA (US); Alex M. Lee, Mountain View, CA (US); Daniel M. Winslow, Gilroy, CA (US); Scott D. Ridel, San Mateo, CA (US); Jere C. Harrison, Redwood City, CA (US); Jacob Barton, Campbell, CA (US); Ehsan Masoumi Khalil Abad, San Jose, CA (US); Kevin Y. Chung, San Jose, CA (US); Jinhong Qu, Santa Clara, CA (US); Sai Sharon Injeti, San Diego, CA (US); Fu-Ying Huang, San Jose, CA (US)

(21) Appl. No.: 18/742,349

(22) Filed: Jun. 13, 2024

Related U.S. Application Data
(60) Provisional application No. 63/541,691, filed on Sep. 29, 2023.

(51) Int. Cl. H01H 13/14; H01H 13/06

(52) U.S. Cl. CPC H01H 13/14; H01H 13/06; H01H 2215/05

(57) ABSTRACT

A device includes a button, a base, a haptic engine coupled to the base, and a fastener fastening the button to the base and allowing movement of the button with respect to the base. The movement of the button with respect to the base enables, in part, a better alignment of the button with a device housing to which the base is attached. The haptic engine may include a core, an electric coil wound around a portion of the core, and an attraction plate separated from the core by a gap. The base may include a frame, a set of tabs extending from the core and fastened to the button to allow the movement of the button with respect to the base, and a set of flexures extending from the tabs and coupling the core to the frame. The attraction plate may also be coupled to the frame.

### CROSS-REFERENCE TO RELATED APPLICATION(S)

This application is a nonprovisional and claims the benefit under 35 U.S.C. § 1.119(e) of U.S. Provisional Patent Application No. 63/541,691, filed Sep. 29, 2023, the contents of which are incorporated herein by reference as if fully disclosed herein.

### FIELD

The described embodiments generally relate to electronic devices and, more particularly, to electronic devices including a button attached to a haptic engine, in which a user's press on the button may be acknowledged by a haptic output provided to the button by the haptic engine.

### BACKGROUND

Modern consumer electronic devices take many shapes and forms and have numerous uses and functions. Smartphones, wearables devices, including wrist-worn devices (e.g., watches or fitness tracking devices) and head-mounted devices (e.g., headsets, glasses, or earbuds), hand-held devices (e.g., styluses, electronic pencils, or communication or navigation devices), computers (e.g., tablet computers or laptop computers), and dashboards, for example, provide various ways for users to interact with others. Such devices may include numerous systems to facilitate such interactions. For example, a smartphone or computer may include a touch-sensitive display for accepting touch or force inputs and providing a graphical output, and many types of electronic devices may include wireless communications systems (e.g., for connecting with other devices to send and receive voice and data content); one or more cameras (e.g., for capturing photographs and videos); or one or more buttons (e.g., depressible buttons, rocker buttons, or crowns (rotatable buttons) that a user may press or otherwise manipulate to provide input to an electronic device).

### SUMMARY

The term embodiment and like terms (e.g., implementation, configuration, aspect, example, and option) are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, the drawings, and each claim.

Some aspects of this disclosure are directed to a device having a button, a base, a haptic engine coupled to the base, and a fastener fastening the button to the base. The fastener may allow movement of the button with respect to the base.

Some aspects of this disclosure are directed to a device having a frame, an attraction plate coupled to the frame, a core coupled to the frame, and an electric coil wound around a portion of the core. The core may have a first stepped surface having portions abutting the frame and a second stepped surface separated from the attraction plate by a gap. A first step of the first stepped surface may have a rounded interior corner. A second step of the second stepped surface may have a square exterior corner.

Some aspects of this disclosure are directed to a device having a frame and a haptic engine. The frame may include a tub, with the tub having a bottom surface and a set of walls surrounding the bottom surface, with each wall attached to the bottom surface and to two adjacent walls. The haptic engine may include an attraction plate coupled to the frame, and a core disposed at least partially within the tub. The core may be separated from the attraction plate by a gap.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the described embodiments, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure will be readily understood by the following detailed description in conjunction with the accompanying drawings, wherein like reference numerals designate like structural elements, and in which:

FIGS. 1A-1C show a front isometric view, a rear isometric view, and a cross-sectional view of an example electronic device having a button and a haptic engine, according to certain aspects of the present disclosure;

FIG. 1D shows a cross-sectional side view of an example button and haptic engine in the electronic device of FIGS. 1A-1C, according to certain aspects of the present disclosure;

FIG. 2 shows an exploded isometric view of an example more detailed implementation of the button and haptic engine of FIG. 1D, according to certain aspects of the present disclosure;

FIGS. 3A-3C show cross-sectional side views of an example haptic module and illustrate vertical movement of a button, from a first position (FIG. 3A) to a second position (FIG. 3B) with respect to a base of the haptic module, and an expanded view of the connections between the button and a haptic module on one side thereof (FIG. 3C), according to certain aspects of the present disclosure;

FIGS. 4A and 4B show cross-sectional side views of an example haptic module and illustrate lateral movement of a button, from a first position (FIG. 4A) to a second position (FIG. 4B) with respect to a base of the haptic module, according to certain aspects of the present disclosure;

FIGS. 5A and 5B show a front isometric view and a rear isometric view, respectively, of a frame that may form part of a base of an example haptic module, according to certain aspects of the present disclosure;

FIGS. 6A and 6B show a front isometric view and a rear isometric view, respectively, of a core forming part a haptic engine of an example haptic module, according to certain aspects of the present disclosure;

FIG. 7 shows a cross-sectional side view of a base of an example haptic module connected to a housing of an electronic device using fasteners and pads, according to certain aspects of the present disclosure;

FIG. 8 shows a cross-sectional side view of a base of an example haptic module connected to a housing of an electronic device using fasteners and shear washers, according to certain aspects of the present disclosure; and

FIG. 9 shows an example electrical block diagram of an electronic device having an example haptic module, according to certain aspects of the present disclosure.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

The present disclosure is susceptible to various modifications and alternative forms, and some representative embodiments have been shown by way of example in the drawings and will be described in detail herein. It should be understood, however, that the described embodiments are not intended to be limited to the particular forms disclosed. Rather, the disclosure is to cover all modifications, equivalents, and alternatives falling within the spirit and scope of the described embodiments as defined by the appended claims.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Some of the embodiments described herein are directed to electronic devices having buttons coupled to haptic engines. Such buttons coupled to haptic engines are at times referred to herein as haptic modules. In some embodiments, a haptic module may include a button, a base, and a haptic engine that is coupled to the base. One or more fasteners may fasten the button to the base. For example, one or more shafts may extend from the button and through a device housing in which the button is incorporated (e.g., through a sidewall of an electronic device in which the haptic module is incorporated), and one or more fasteners (e.g., one or more screws, such as one or more shoulder screws) may extend through the base and into a respective threaded hole or holes in the shaft(s), thereby coupling the haptic module to the electronic device. The fastener(s) may allow movement of the button with respect to the base, which can improve the installation of the button in the electronic device (e.g., help account for manufacturing tolerances and potential button alignment and/or install issues that the manufacturing tolerances might cause). In some embodiments, the fastener(s) may allow the button to move toward and away and/or side-to-side with respect to the base.

When the haptic module is installed in an electronic device, the button may be exterior to the device housing (and operable by a user), and the base, haptic engine, and fastener(s) may be interior to the device housing. The shaft(s) (or other features) that extend from the button may pass through the device housing.

In some embodiments, the haptic engine may be an electromagnetic haptic engine and include a core, an electric coil wound around a portion of the core, and an attraction plate (e.g., a magnetic attraction plate).

In some embodiments, the base to which the button is fastened may include one or more tabs that extend from (or are attached to) the core of the haptic engine. The base may also include, for example: a frame disposed about the core or other portions of the haptic engine; and one or more flexures that couple the core to the frame and/or to the device housing. In some embodiments, one portion (e.g., a first end) of a flexure may be welded or otherwise attached to the core (e.g., to a tab that extends from the core), and another portion (e.g., a second end) of the flexure may be welded or otherwise attached to the frame (e.g., crimped, fastened, or interconnected). The attraction plate may also be welded or otherwise attached to the frame (e.g., crimped, fastened, or interconnected). When a user presses the button, the core may move slightly toward the attraction plate. One or more force sensors (e.g., one or more strain gauges) attached to the haptic module may be used to detect the user's press. In response to a processor or other circuitry detecting the press, an electrical signal may be applied to the electric coil. Together, the energized electric coil and core may generate a magnetic field, and in some cases a time-varying magnetic field that causes a magnetic attraction between the core and the attraction plate. The magnetic attraction may cause one or both of the core or the attraction plate to move, and in some cases vibrate, to produce a haptic output at the button. In some cases, an electrical signal may be applied to the electric coil, to produce a haptic output, even in the absence of detecting a user press on the button.

In some embodiments, the base may be attached to the device housing at points other than where the base is attached to the button (e.g., by one or more additional fasteners). The fastener(s) that attach the base to the device housing may allow for less (or no) movement of the base where it is attached the device housing. Thus, there may be little to no allowance for manufacturing tolerances with respect to attachment of the base to the device housing. However, manufacturing tolerances in the button, or manufacturing tolerances in the button-to-base attachment, may be accounted for by means of the movement that is allowed between the button and the base. In some embodiments, the hole(s) in the device housing, through which the shaft(s) extend, may be sized somewhat larger than the cross-section(s) of the shaft(s), and the slack between a button shaft and the device housing may be filled by a compressible gasket (e.g., an O-ring) disposed about a button shaft.

In some embodiments, the core may have a first stepped surface with portions abutting the frame, and a second stepped surface, opposite to the first stepped surface, that is separated from the attraction plate by a gap. One or more steps of the first stepped surface may have a rounded interior corner, which can reduce stress and the likelihood of a crack in comparison to a square interior corner and provide structural robustness. In contrast, one or more steps of the second stepped surface may have a square exterior corner (or a nearly square exterior corner, such as within 3-5% of square), which can increase the surface area of the core that defines the gap (or the surface area that defines the smallest gap) between the core and the attraction plate and maximize the magnetic field generated by the core.

In some embodiments, the frame to which the core is attached may include a tub having a bottom surface and a set of walls. Each wall may be attached to the bottom surface and to two adjacent walls. In some examples, the core may be at least partially disposed in the tub; and in some examples, the bottom surface of the tub may define an opening through which the core extends. In some embodiments, the frame may be formed with stainless steel and the tub may be shaped using a deep drawn metal-forming process (i.e., a process that forma a deep drawn tub). The use of a frame having a tub, vs just a bent piece of metal, can provide more rigidity for the portions of the haptic module which are not intended to move, which can improve consistency in the size of a gap between the core and the attraction plate of the haptic engine; help to prevent damage to the haptic module during handling and/or impact (e.g., a device drop); and so on.

In some embodiments, the structural robustness of the haptic module and/or user satisfaction with operation of the haptic module may be enhanced by using pads or shear washers disposed on interfaces between the frame and various fasteners, between the frame and the device housing, or elsewhere. In some embodiments, such pads or shear washers may reduce or eliminate audio waveforms (e.g., noises created by two metallic parts coming into contact with each other) that are unintended and may be heard by a user.

While the specific haptic modules shown in the figures are described below with respect to a particular handheld electronic device, the embodiments described herein may be used with various electronic devices including, but not limited to, smartphones, wearables devices, including wrist-worn devices (e.g., watches or fitness tracking devices) and head-mounted devices (e.g., headsets, glasses, or earbuds), hand-held devices (e.g., styluses, electronic pencils, or communication or navigation devices), computers (e.g., tablet computers or laptop computers), and dashboards. Although various electronic devices are mentioned, the haptic modules of the present disclosure may also be used in conjunction with other products and combined with various materials.

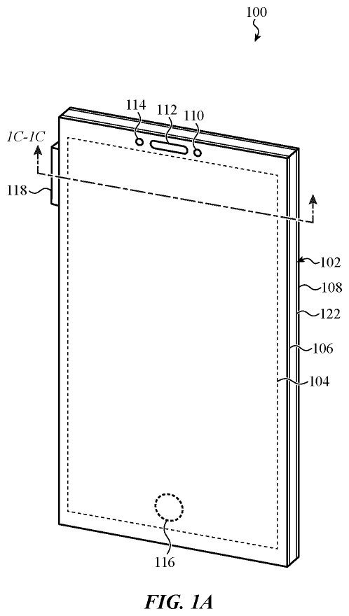

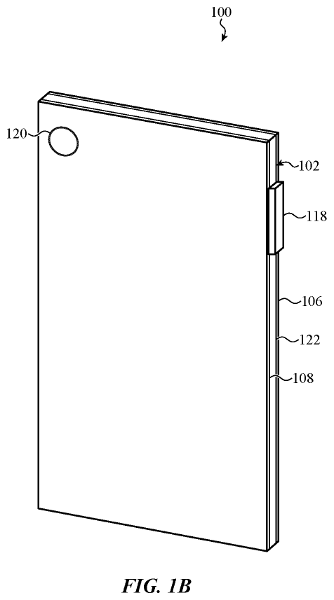

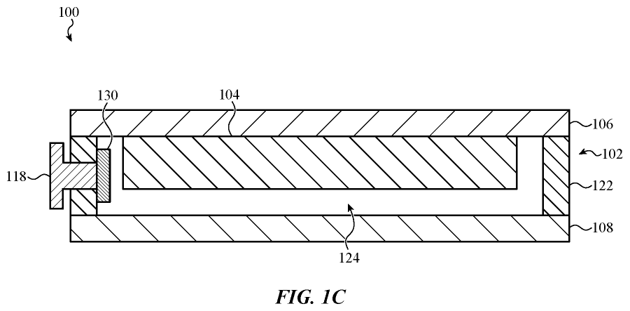

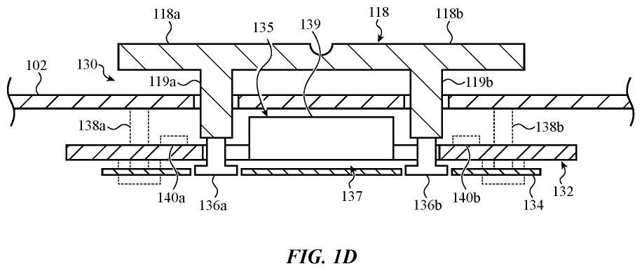

These and other embodiments are discussed below with reference to FIGS. 1A-9. However, those skilled in the art will readily appreciate that the detailed description given herein with respect to these figures is for explanatory purposes only and should not be construed as limiting.

FIGS. 1A-1C show an example of an electronic device or simply “device” 100. The device's dimensions and form factor, including the ratio of the length of its long sides to the length of its short sides, suggest that the device 100 is a mobile phone (e.g., a smartphone). However, the dimensions and form factor of the device are arbitrarily chosen, and the device 100 could alternatively be any portable electronic device including, for example a mobile phone, tablet computer, portable computer, portable music player, health monitor device, portable terminal, or other portable or mobile device. FIG. 1A shows a front isometric view of the device 100; FIG. 1B shows a rear isometric view of the device 100; and FIG. 1C shows an example cross-section of the device 100 taken along 1C-1C of FIG. 1A. The device 100 may include a device housing 102 that at least partially surrounds a display 104. The device housing 102 may include or support a front cover 106 or a rear cover 108. The front cover 106 may be positioned over the display 104 and may provide a window through which the display 104 may be viewed. In some embodiments, the display 104 may be attached to (or abut) the device housing 102 and/or the front cover 106.

As shown in FIGS. 1A and 1B, the device 100 may include various other components. For example, the front of the device 100 may include one or more front-facing cameras 110, speakers 112, microphones, or other components 114 (e.g., audio, imaging, or sensing components) that are configured to transmit or receive signals to/from the device 100. In some cases, a front-facing camera 110, alone or in combination with other sensors, may be configured to operate as a bio-authentication or facial recognition sensor. The device 100 may also include various input devices, including a mechanical or virtual button 116, which may be located along the front surface of the device 100. The device 100 may also include one or more buttons or other input devices (e.g., button 118) positioned along a sidewall 122 of the device housing 102 and/or on rear surface of the device 100. By way of example, the rear surface of the device 100 is shown to include a rear-facing camera 120 or another optical sensor (see, FIG. 1B). A flash or light source may also be positioned along the rear of the device 100 (e.g., near the camera 120). In some cases, the rear surface of the device may include multiple rear-facing cameras.

As discussed previously, the device 100 may include a display 104 that is at least partially surrounded by the device housing 102. The display 104 may include one or more display elements including, for example, light-emitting display (LED), organic light-emitting display (OLED), liquid crystal display (LCD), electroluminescent display (EL), or other type of display elements. The display 104 may also include one or more touch and/or force sensors that are configured to detect a touch and/or a force applied to a surface of the front cover 106. The touch sensor may include a capacitive array of nodes or elements that are configured to detect a location of a touch on the surface of the front cover 106. The force sensor may include a capacitive array and/or strain sensor that is configured to detect an amount of force applied to the surface of the front cover 106.

FIG. 1C depicts a cross-section of the device 100 shown in FIGS. 1A and 1B taken along 1C-1C of FIG. 1A. As shown in FIG. 1C, the rear cover 108 may be a discrete or separate component that is attached to the sidewall 122. In other cases, the rear cover 108 may be integrally formed with part or all of the sidewall 122.

As shown in FIG. 1C, the sidewall 122 or device housing 102 may define an interior volume 124 in which various electronic components of the device 100, including the display 104, may be positioned. In this example, the display 104 is at least partially positioned within the interior volume 124 and attached to an inner surface of the front cover 106. A touch sensor, force sensor, or other sensing element may be integrated with the front cover 106 and/or the display 104 and may be configured to detect a touch and/or force applied to an outer surface of the front cover 106. In some cases, the touch sensor, force sensor, and/or other sensing element may be positioned between the front cover 106 and the display 104, within or in back of a stack including the display 104, between the front cover and the sidewall 122, or at other locations within the device 100.

In some embodiments, the touch sensor and/or force sensor may include an array of electrodes that are configured to detect a location and/or force of a touch using a capacitive, resistive, strain-based, ultrasonic, or other sensing configuration. The touch sensor may include, for example, a set of capacitive touch sensing elements, a set of resistive touch sensing elements, or a set of ultrasonic touch sensing elements. When a user of the device touches the front cover 106, the touch sensor (or touch sensing system) may detect one or more touches on the front cover 106 and determine locations of the touches on the front cover 106. The touches may include, for example, touches by a user's finger or stylus. A force sensor or force sensing system may include, for example, a set of capacitive force sensing elements, a set of resistive force sensing elements, or one or more pressure transducers. When a user of the device 100 presses on the front cover 106 (e.g., applies a force to the front cover 106), the force sensing system may determine an amount of force applied to the front cover 106. In some embodiments, the force sensor (or force sensing system) may be used alone or in combination with the touch sensor (or touch sensing system) to determine a location of an applied force, or an amount of force associated with each touch in a set of multiple contemporaneous touches.

FIG. 1C further shows the button 118 along the sidewall 122. The button 118 may be accessible to a user of the device 100 and extend outward from the sidewall 122. In some cases, a portion of the button 118 may be positioned within a recess in the sidewall 122. Alternatively, the entire button 118 may be positioned within a recess in the sidewall 122 and the button 118 may be flush with the housing (or inset into the housing).

The button 118 may extend through the housing and attach to a haptic engine and force sensor disposed within the interior volume 124; the haptic engine and force sensor are represented in block form by a haptic module 130. Example implementations of button 118 and the haptic module 130 are described in detail elsewhere herein. By way of example, the haptic engine may be an electromagnetic haptic engine. The force sensor may include, for example, a capacitive force sensor, a resistive force sensor (e.g., a strain gauge), a pressure sensor, or a switch (e.g., a compressible switch or a pair of electrical contacts that open or close a circuit when the button 118 is pressed).

The haptic engine of the haptic module 130 may produce a tactile or haptic output in response to the force sensor detecting any force, or in response to the force sensor detecting a force that satisfies a condition. Thus, for example, upon detecting a strain that satisfies a condition (and/or another electrical parameter that is indicative of a force satisfying the condition), the haptic engine may impart a haptic output on the button 118 (e.g., a haptic output resembling a “click”, or a haptic output that is more complex). This haptic output may indicate to the user that the user's press was recognized by the device. In some embodiments, a haptic output may also or alternatively be provided in response to a touch being detected on the button 118. In some embodiments, different haptic outputs may be provided, for example, in response to where a user touches or presses the button 118, or in response to how hard or how long the user presses the button 118, or in response to a context of what is displayed on the display 104 and/or an active application, or in response to an ambient condition of the device 100.

FIG. 1D shows a cross-sectional side view of an example configuration of a button, such as the button 118 of the device 100. A user may press the button 118 toward the device housing 102 (e.g., a device housing) to actuate the button 118 and provide an input to the device 100. In some embodiments, the button 118 may have a singular actuation region. In some embodiments, the button 118 may have a singular shaft that extends through an opening in the device housing 102. The button 118, however, is shown to have different actuation regions 118a, 118b. The button 118 is also shown to include multiple shafts (e.g., first and second shafts 119a, 119b) that extend from the button 118 and through respective openings defined by the device housing 102. The shafts 119a, 119b may be coupled to a base 132, interior to the device housing 102, by one or more fasteners 136a, 136b (e.g., screws, rivets, welded or glued plugs or stops, etc.). Although the embodiments described in this disclosure, are directed to a button 118 that includes two actuation regions and two shafts extending through a device housing, it is understood that different buttons may have more or fewer actuation regions, as well as more or fewer shafts extending from the button and through a device housing.

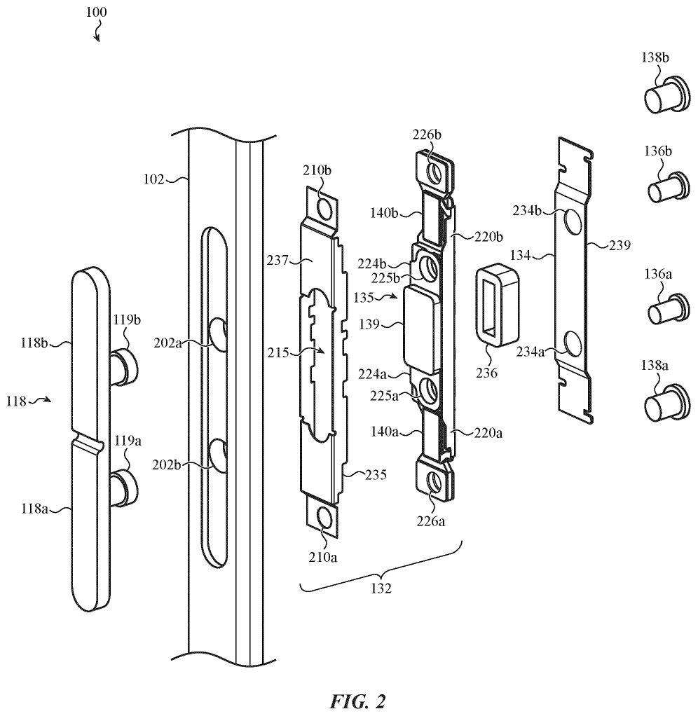

The base 132 shown in FIG. 1D is relatively simplistic and includes a plate (or frame) that may be optionally coupled to the device housing 102 by one or more fasteners 138a, 138b (e.g., one or more screws). In some embodiments, the base 132 may be rigidly attached to the device housing 102. In contrast, the fasteners 136a, 136b may fasten the button 118 to the base 132 such that the button 118 can move with respect to the base 132. The movement may be in any direction, including, for example, up and down, side to side, and into and out of the page given the view shown in FIG. 1D. This allowed movement may enable small misalignments between the holes in the base 132 and the holes in the device housing 102. In the case of a button 118 that sits partially or fully within a cavity (e.g., as shown in FIG. 2), the allowed movement may also allow the button to be centered within the cavity. Compressible gaskets (e.g., O-rings) may surround the shafts 119a, 119b and fill any gaps between the shafts 119a, 119b and the device housing 102. A user's press on the button 118 may hold the button 118 in consistent enough contact with the base 132 for a haptic engine 135 to transfer a haptic output to the button 118 via the base 132.

As shown, each shaft 119a, 119b may have an end that faces a first surface of the base 132, and each fastener 136a, 136b may have a head that faces a second surface of the base 132, such that, after the fasteners 136a, 136b are attached to the shafts 119a, 119b, the base 132 is retained between the ends of the shafts 119a, 119b and the heads of the fasteners 136a, 136b. However, when the end of a shaft 119a or 119b abuts the base 132, the head of a corresponding fastener 136a or 136b does not abut the base 132, and vice versa. Similarly, when the head of a fastener 136a or 136b abuts the base 132, the end of a corresponding shaft 119a or 119b does not abut the base 132.

The haptic engine 135 may be attached to the base 132. The haptic engine 135 may include a core 139, an electric coil disposed around at least a portion of the core 139, and an attraction plate 134, as further discussed herein. In FIG. 1D, the core 139 houses the electric coil (not shown).

In some embodiments, the attraction plate 134 may be attached to the base 132 and separated from the core 139 by a gap 137. In other embodiments, the attraction plate 134 may be attached to another component of the device 100 and separated from the core 139 by a gap 137. In other embodiments, the attraction plate 134 may be positioned between the core 139 and the device housing 102 and attached, for example, to the device housing 102 or to the base 132.

The shafts 119a, 119b may be fastened to the base 132 such that forces applied to the button 118 may be transferred to the base 132, and such that a haptic output applied to the base 132 (e.g., due to operation of the haptic engine 135) may be transferred to the button 118.

One or more sensing elements 140a, 140b (e.g., force sensors) coupled to the base 132 may detect deflection of the base 132 as a result of a force applied to the button 118. The sensing elements 140a, 140b may include, for example, strain sensing elements (e.g., strain gauges, piezoelectric and/or piezoresistive materials, etc.) or other components or materials that detect deflection of the base 132 (optionally in conjunction with other circuitry). Each of the sensing elements 140a, 140b may produce a respective electrical signal that varies with the deflection of the base 132. The device 100 may determine, based at least in part on the signal(s) produced by the sensing element(s) 140a, 140b, the presence of a force on the button 118 and, in some cases, a location of a force on the button 118 (e.g., a force applied to actuation region 118a versus a force applied to actuation region 118b). The device 100 may correlate different combinations of signals received from two or more sensing elements 140a, 140b to different locations of an applied force, and may perform different actions or operations based at least in part on the location of an applied force, an amount or duration of the applied force, and/or whether the location or amount or duration of the applied force satisfies one or more conditions for a particular action or operation to be performed.

When the button 118 is pressed, the press causes the base 132 to deflect. The base 132 may be constrained, relative to the device housing 102, such that forces imparted by the button 118 (e.g., forces in a vertical direction relative to the orientation of FIG. 1D) cause the base 132 to be deflected relative to the device housing 102 and/or other components of the device 100. In some cases, one or both ends of the base 132 may be fixed relative to the device housing 102 (and optionally relative to the attraction plate 134). In some cases, one or both ends of the base 132 may be constrained in one direction (e.g., vertical), but movement may be allowed in another direction (e.g., a horizontal direction). One or both ends of the base 132 may be constrained in various ways, such as by the fasteners 138a, 138b that are coupled to the device housing 102.

The base 132 may generally bias the button 118 to an undepressed or unactuated position and may have a stiffness that provides a tactile resistance to an input force (such that the user can tactilely feel that they are pressing against a button that has some compliance while also providing some resistance). The tactile resistance may increase as the base 132 is deflected, such that the user can feel the increasing resistance as the button is pressed.

The haptic engine 135 attached to the base 132 may be activated in response to a press of the button 118 (e.g., when the user presses the button with sufficient force and/or a sufficient distance to cause the device to register an input). When activated, the core 139 of the haptic engine 135 may attract or repulse the attraction plate 134, which is spaced apart from the core 139 by a gap 137. The attraction and/or repulsion deflects the base 132 and moves the button 118 toward or away from the exterior of the device housing 102. In some embodiments, the button 118 may be configured such that the deflection caused by the haptic engine 135 is less than a dimension of the gap 137, such that the base 132 does not contact the attraction plate 134 during its haptic movement.

The haptic engine 135 may initiate the haptic output when the button 118 has moved a particular distance (and/or in response to another input condition being satisfied) and may move the button 118. The movement of the button 118 (e.g., movement of the button 118 away from the user's finger, followed by a subsequent release of the button 118) may be perceived by a user as a button “click,” which may provide tactile feedback to the user that an input has been registered. The haptic engine 135 may also cycle between pushing and pulling the button 118 to produce oscillations or other haptic effects.

The haptic engine 135 may be configured to produce haptic outputs in response to various input conditions being satisfied, and the device 100 may perform different operations in response to the different input conditions being satisfied (e.g., different amounts of force and/or deflection thresholds being met, different locations of force, and/or different durations of an applied force). Haptic outputs may also have different durations. The particular duration of a haptic output may depend on various factors, including but not limited to a state or mode of operation of the device (e.g., an application that is being executed, a user interface that is being displayed, etc.), a type of input condition that is satisfied and/or triggers the haptic output, an amount of force applied to the button, a duration of an input, and the like.

FIG. 2 shows an exploded isometric view of an example more detailed implementation of the button and haptic engine 135 described with reference to FIG. 1D. The device 100 may include a housing 102 (e.g., a device housing). The device housing 102 may define a first opening 202a and a second opening 202b. The button 118 may be positioned external to the device housing 102, and the haptic engine 135 may be positioned internal to the device housing 102. Two shafts 119a, 119b may extend from the button 118. The button 118 may include actuation regions 118a, 118b that are more or less aligned with (or associated with) respective one of the shafts 119a, 119b. The shafts 119a, 119b may extend through respective ones of the first and second openings 202a, 202b in the device housing 102, and may be attached to the base 132.

The haptic engine 135 may include a core 139 and an electric coil 236 disposed around at least a portion of the core 139. The core 139 may be formed from a ferromagnetic material, ferrimagnetic material, or other suitable material (e.g., iron, ferrite, steel, ferrous materials, a permanent magnet, iron alloys, etc.). In order to produce a haptic output at the button 118, the electric coil 236 surrounding the core 139 may be energized (e.g., by a circuit that applies a current or current waveform to the electric coil 236), which causes the core 139 to be attracted to the attraction plate 134. The core 139 may have a first tab 224a and a second tab 224b extending from respective opposite sides of the core 139. The first tab 224a may have a first aperture 225a that receives a first fastener 136a that fastens the first tab 224a to the button 118. The second tab 224b may have a second aperture 225b that receives a second fastener 136b that fastens the second tab 224b to the button 118. The first and second tabs 224a, 224b may be considered part of a base 132.

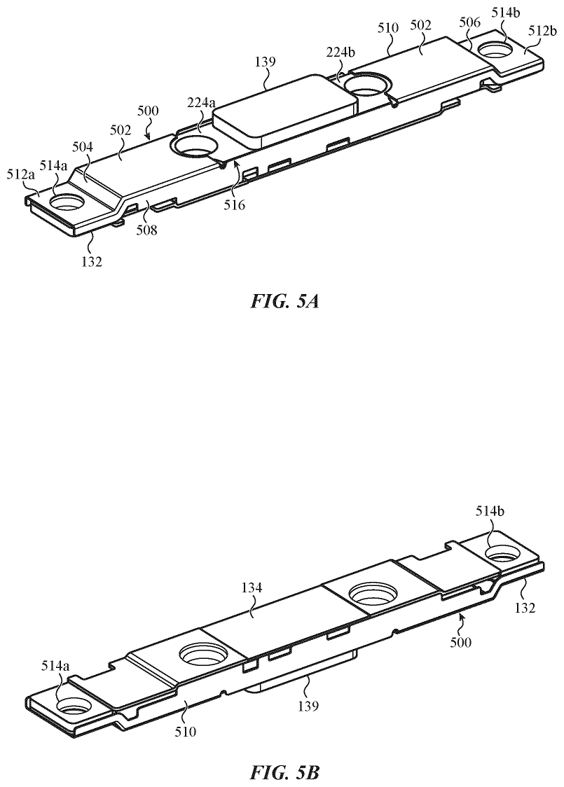

The haptic module 130 of the device 100 may include the base 132 and the haptic engine 135. In addition to the tabs 224a, 224b (or other means for connecting the button 118 to the core 139), the base 132 may include a pair of flexures 220a, 220b and a frame 235. The frame 235 shown in FIG. 2 is merely an example and, in different embodiments, the frame 235 may incorporate a variety of designs such as those described with reference to FIGS. 5A and 5B. The pair of flexures 220a, 220b may be coupled to the tabs 224a, 224b, and thereby to the core 139. In some embodiments, the flexures 220a, 220b may be welded to the tabs 224a, 224b, and thereby to the core 139. The flexures 220a, 220b may also be coupled to opposite ends of the frame 235. The frame 235 may include a central opening 215 and respective apertures 210a, 210b along flanged ends thereof. Each of the two flexures 220a, 220b may include respective apertures 226a, 226b that are distal from the core 139. The apertures 226a, 226b of the flexures 220a, 220b align with the respective apertures 210a, 210b of the frame 235. Fasteners 138a, 138b aligned with the apertures 210a/226a or 210b/226b may couple the flexures 220a, 220b to both the frame 235 and the device housing 102. In some embodiments, the flexures 220a, 220b may also be welded to respective portions of the frame 235 (e.g., near or around the apertures 210a/226a and 210b/226b).

The two flexures 220a, 220b may have respective sensing elements 140a, 140b (e.g., strain gauges) mounted thereon, which sensing elements 140a, 140b can detect and/or measure deflections of the respective flexures 220a, 220b in response to a force applied by a user to the button 118.

The attraction plate 134 may be attached to the frame 235 by means of welds or crimping, for example. The attraction plate 134 may include a pair of apertures 234a, 234b that allow the fasteners 136a, 136b to pass through the attraction plate 134 without contacting the attraction plate 134.

When a user presses on the button 118, an applied force is transferred from the button to one or both of the tabs 224a, 224b. Because the tabs 224a, 224b are attached to the core 139, the force moves the core 139 toward the attraction plate 134, reducing the size of a gap therebetween. Because the tabs 224a, 224b are attached to the flexures 220a, 220b, the flexures may flex, and the sensing elements 140a, 140b may generate one or more electrical signals indicating that the button 118 has been pressed. In some cases, the one or more electrical signals may indicate a location of the press and/or an amount of force associated with the press. In response to a processor or other circuit (not shown) determining the presence of a user-applied force on the button 118, or the presence of a force having a particular magnitude, and/or a force applied at a particular location, the processor or other circuit may apply an electrical signal to the electric coil 236, which electrical signal, in combination with the electric coil 236 and the core 139, may create a magnetic field that causes the core 139 to be attracted to the attraction plate 134, thereby moving the button 118 to provide a haptic output at the button 118. Modulation of the electrical signal applied to the electric coil 236 may cause the button 118 to move in a desired way, to provide a desired haptic output. In some embodiments, the button 118 may be moved in different ways, under different conditions, to provide different haptic outputs.

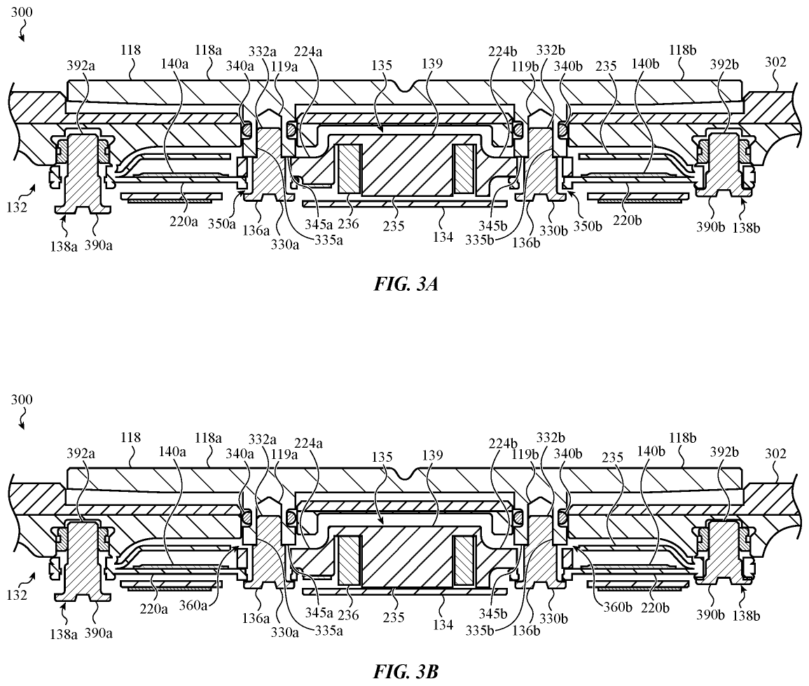

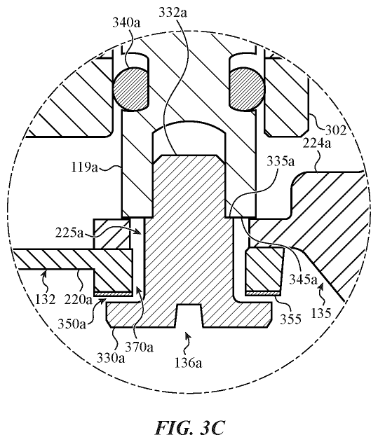

FIGS. 3A and 3B show cross-sectional side views of an example haptic module 300 and illustrate vertical movement of a button 118, from a first position (FIG. 3A) to a second position (FIG. 3B) with respect to a base 132 of the haptic module 300. The button 118 may include shafts 119a, 119b that extend from the button 118 and through openings in a device housing 302. In some embodiments, the button 118 may have a user input surface that defines different actuation regions (e.g., first and second actuation regions 118a, 118b) that may be visually and/or tactilely distinct from one another (e.g., separated by a channel, ridge, groove, marking, bump, etc.).

The shafts 119a, 119b may be coupled to a base 132 that includes a pair of tabs 224a, 224b extending from a core 139 of the haptic engine 135, a pair of flexures 220a, 220b, and a frame 235. The first flexure 220a may have a first sensing element 140a thereon, and the second flexure 220b may have a second sensing element 140b thereon. The first flexure 220a and the second flexure 220b may be separate components that are coupled to the tabs 224a, 224b, and may be positioned on opposite sides of the haptic engine 135 proximate opposite ends of the frame 235. The first flexure 220a and the second flexure 220b may be rigidly coupled to the tabs 224a, 224b (e.g., via welds, fasteners, etc.). As described above, the sensing elements 140a, 140b may be or include strain gauges, or other components or materials that detect deflection of the base 132 (and more particularly, the two flexures 220a, 220b).

The haptic engine 135 may include an electromagnetic core 139, which may be formed from a ferromagnetic material, ferrimagnetic material, or other suitable material (e.g., iron, ferrite, steel, ferrous materials, permanent magnet, etc.). In some embodiments, the core 139 may be formed from an alloy including iron, cobalt, and/or vanadium. The haptic engine 135 may further include an electric coil 236 that surrounds a portion of the core 139. As described above, when tactile feedback (e.g., haptic output) is to be produced at the button 118, the electric coil 236 may be energized, which causes the core 139 to be attracted to the attraction plate 134.

The button 118 may be coupled to the base 132 (e.g., to the tabs 224a, 224b) via a first set of fasteners 136a, 136b (e.g., screws). The fasteners 136a, 136b may secure the button 118 to the base 132 such that input forces applied to the button 118 are transferred to the base 132 through the respective shafts 119a, 119b. In some embodiments, the shafts 119a, 119b may have threaded cylindrical holes that extend into ends 345a, 345b facing the base 132 (e.g., a top surface of the base 132). In some examples, each of the fasteners 136a, 136b may be a shoulder screw having a respective head 330a, 330b and a respective shoulder 335a, 335b. The respective shoulder 335a, 335b has a height that is sized to allow movement of the button 118 with respect to the base 132. A portion of each shoulder 335a, 335b that is distal from the head 330a, 330b may abut a respective end 345a, 345b of a respective shaft 119a, 119b of the button 118. When the button 118 is at a first position (FIG. 3A) with respect to the base 132, the ends 345a, 345b of the shafts 119a, 119b may abut surfaces of the base 132 (e.g., portions of the tabs 224a, 224b), and the heights of the shoulders 335a, 335b prevent the heads 330a, 330b of the fasteners 136a, 136b from contacting the base 132 (e.g., portions of the flexures 220a, 220b), leaving respective gaps 350a, 350b between the heads 330a, 330b of the fasteners 136a, 136b and the base 132. When the button 118 is at a second position (FIG. 3B) with respect to the base 132, the heads 330a, 330b of the fasteners 136a, 136b abut surfaces of the base 132 (e.g., portions of the flexures 220a, 220b) and the heights of the shoulders 335a, 335b prevent the ends 345a, 345b of the shafts 119a, 119b from contacting the base 132 (e.g., portions of the tabs 224a, 224b), leaving respective gaps 360a, 360b between the ends 345a, 345b of the shafts 119a, 119b and the base 132.

The input forces that are transferred to the base 132 in response to presses of the button 118 result in the flexures 220a, 220b deforming. The base 132 may be coupled to the device housing 302 via a second set of fasteners 138a, 138b. Each of the fasteners 138a, 138b may have a respective head 390a, 390b and a respective threaded shaft 392a, 392b extending from its respective head 390a, 390b. The heads 390a, 390b may engage with the base 132, and the threads of the threaded shafts 392a, 392b may engage respective threaded holes in the device housing 302, to secure the base 132 to the device housing 302.

FIG. 3C shows an expanded view of the connections between the button 118 and the base 132 on one side of the haptic module 300. While FIG. 3C describes the connections with respect to one side of the haptic module 300, similar components and connections are presented for the other side of the haptic module 300. As shown, the fastener 136a (e.g., a screw) may extend through the aperture 225a that is formed in the first tab 224a, which is attached to the core 139, and through a corresponding aperture in the first flexure 220a, and into an opening defined in the end 345a of the shaft 119a of the button 118. Similarly, the fastener 136b (e.g., a threaded fastener) may extend through the aperture 225b that is formed through the second tab 224b attached to the core 139, and through a corresponding aperture in the second flexure 220b, and into an opening defined in the end 345b of the shaft 119b of the button 118.

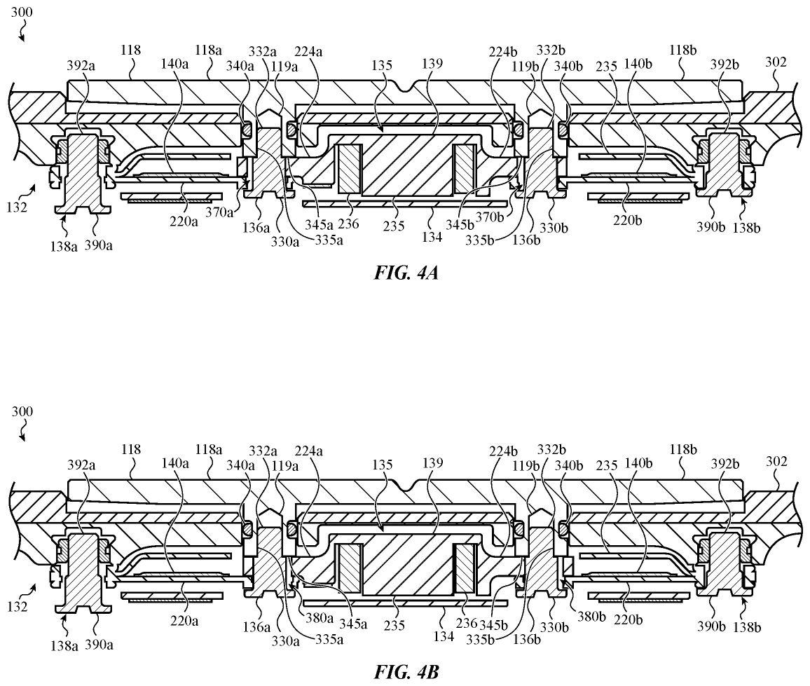

In some cases, the fasteners 136a, 136b may be configured to retain the button 118 to the base 132 without rigidly coupling the button 118 to the base 132. By allowing some degree of movement between these components, the likelihood of the button 118 binding, racking, or otherwise interfering with other structures may be reduced while also allowing the button 118 to impart a sufficient force onto the base 132 (e.g., as a result of a force applied to the button 118) and allowing the base 132 to transfer a force to the button 118 (e.g., to produce a haptic output). The gap 350a, and the shoulder diameter of the fastener 136a being smaller than the diameter of the aperture 225a to create gap 370a, may allow movement of the button in all directions relative to the base 132. For example, the button 118 may move vertically (e.g., as oriented in FIG. 3C), between a first position (FIG. 3A) and a second position (FIG. 3B), and horizontally (e.g., as oriented in FIG. 3C), between a first position (FIG. 4A) and a second position (FIG. 4B).

The sizes of the gaps may be selected so that the distance of travel of the button 118 during reception of user input (i.e., a user applied force), and during generation of a haptic output, is greater than the dimensions of the gaps. For example, the respective gaps 350a, 350b may be between about 10 and about 50 microns, while a user input may move the button 118 between about 100 and about 200 microns, and the haptic engine 135 may be configured to move the base 132 between about 100 and about 200 microns. Thus, the movements of the components produced by user input and haptic output will close any gaps while also allowing sufficient engagement between the components to transfer forces between the components (e.g., so the button 118 can deflect the base 132 in response to the user input and the base 132 can move the button 118 to produce the haptic output).

In some examples, a compressible gasket (e.g., an O-ring 340a, as shown in FIG. 3C) may surround each of the shafts 119a, 119b that extend from the button 118, with the compressible gaskets providing a centering force to position the button 118 in a target position relative to the device housing 302.

In some cases, a pad 355 may be provided between respective heads 330a (shown in FIG. 3C), 330b of the fasteners 136a, 136b and the base 132. The pad 355 may be configured to provide a compliant interface between the fasteners 136a, 136b and the base 132 during user input and haptic output. For example, in order to produce a haptic output, the haptic engine 135 may be energized such that the base 132 is pulled downward (relative to the orientation in FIG. 3C) to a second position, as shown in FIG. 3B. This downward movement may cause the base 132 to close the gaps 350a, 350b and begin pulling the button 118 downward. The pad 355 may reduce friction between the base 132 and the fasteners 136a, 136b during this engagement, and may also reduce audible noise that might otherwise occur due to contact between these components. The pad 355 may be formed of or include a polymer material (e.g., nylon, polyethylene terephthalate (PET)), or any other suitable material that is softer than the material of the base 132. The pad 355 may be adhered to or otherwise attached to the base 132 or the fasteners 136a, 136b, or may be free-floating between these components (e.g., as a compressible and expandable washer that fills the gaps 350a, 350b).

FIGS. 4A and 4B show cross-sectional side views of the example haptic module 300 shown in FIGS. 3A and 3B and illustrate lateral movement of the button 118 from a first position (FIG. 4A) to a second position (FIG. 4B) with respect to the base 132 of the haptic module 300. FIGS. 4A and 4B show a similar setup as FIGS. 3A and 3B, except that input forces on the button 118 are shown to cause lateral movement of the button 118 with respect to the base 132, such that the respective gaps 370a, 370b (FIG. 4A) between the respective shafts 332a, 332b of the fasteners 136a, 136b and the apertures in the flexures 220a, 220b of the base 132 close, and respective gaps 380a, 380b (FIG. 4B) emerge between the shafts 332a, 332b of the fasteners 136a, 136b and the apertures in the flexures 220a, 220b. This allows the button 118 to self-center to a non-binding and/or non-interfering horizontal position with respect to the base 132.

FIGS. 5A and 5B show a top isometric view and a bottom isometric view, respectively, of a frame 500 that may form part of a base 132 of a haptic module (e.g., haptic module 300 in FIGS. 3A and 3B). The frame 500 may be formed with a deep drawn metal forming process. The frame 500 may include a tub having a bottom surface 502 and a set of walls (504, 506, 508, 510). In FIG. 5A, the tub is shown in an inverted orientation. Each wall in the set of walls 504, 506, 508, 510 may be attached to the bottom surface 502 and to two adjacent walls of the set of walls 504, 506, 508, 510. For example, the wall 508 may be attached to walls 504 and 506. A first flexure mount surface 512a may extend from a first wall (e.g., wall 504) and a second flexure mount surface 512b may extend from a second wall (e.g., wall 506), with the first and second flexure mount surfaces 512a, 512b extending in opposite directions from the tub. A first flexure (shown in other figures) may be attached (e.g., welded) to both the first flexure mount surface 512a and to a core 139 of a haptic engine (e.g., via a tab 224a extending from the core 139). A second flexure (shown in other figures) may be attached (e.g., welded) to both the second flexure mount surface 512b and to the core 139 (e.g., via a tab 224b extending from the core 139). The first and second flexures allow the core 139 to move with respect to the frame 500.

The first and second flexure mount surfaces 512a, 512b may have respective holes 514a, 514b therein for receiving fasteners (e.g., screws) that attach the frame 500 to a device housing.

The frame 500 may be additionally attached to an attraction plate 134 of the haptic engine. The core 139 of the haptic engine may be at least partially enclosed by the frame 500. In some embodiments, the bottom surface 502 of the tub may have an opening 516 through which the core 139 protrudes.

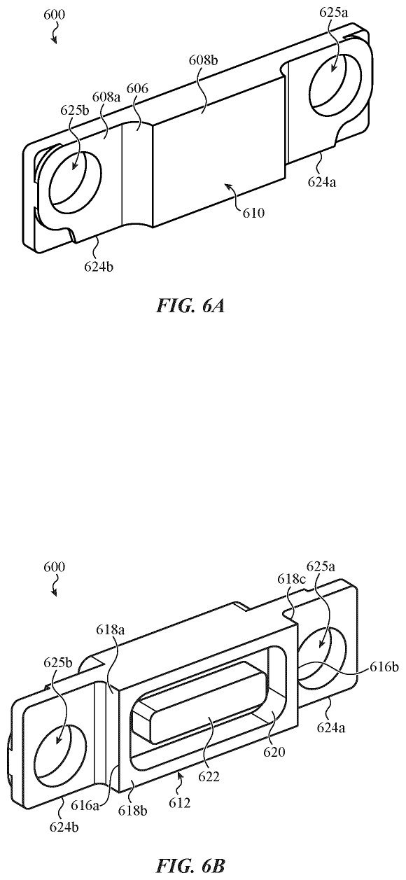

FIGS. 6A and 6B show a front isometric view and a rear isometric view, respectively, of a core 600 forming part of a haptic engine in an example haptic module (e.g., haptic module 300 in FIGS. 3A and 3B). The core 600 is formed from substantially similar materials as the electromagnetic core described above with respect to FIG. 2. In some embodiments, the core 600 may be made from an alloy such as, but not limited to, stainless steel, or an alloy including iron, cobalt, and/or vanadium. In some examples, the core 600 may be nickel-plated and have the nickel-plating etched at weld locations (e.g., where it is attached to the flexures in FIG. 2).

The core 600 may have a first stepped surface 610 that is configured to be coupled to a frame (e.g., the frame in FIG. 2), and a second stepped surface 612 that is configured to face an attraction plate (e.g., the attraction plate in FIG. 2). The first and second stepped surfaces 610, 612 are formed, in part, by first and second tabs 624a, 624b that extend from respective opposite sides of the core 600. Each of the first and second tabs 624a, 624b may include a respective aperture 625a, 625b that may receive a respective fastener for attaching the core 600 to a button (e.g., the button described with reference to other figures).

The first stepped surface 610 (FIG. 6A) may have rounded interior corners (e.g., rounded interior corner 606 between adjacent portions 608a and 608b of the first stepped surface 610. The rounded interior corners remove sharp step transitions that might otherwise form a transition where the tabs 624a, 624b might be prone to breaking off from the body of the core 600.

The second stepped surface 612 (FIG. 6B) may have square exterior corners 616a, 616b (or nearly square exterior corners, such as within 3-5% of square) between adjacent portions 618a and 618b, and 618b and 618c, of the second stepped surface 612. The square exterior corners maximize the surface area of the core that defines a smallest gap between the core 600 and an attraction plate.

A cavity 620 may extend into the second stepped surface 612. A post 622 (or island) within the cavity 620 may be the portion of the core 600 around which an electric coil (e.g., the electric coil in FIG. 2) is wound. While in the embodiment shown in FIG. 6B, the cavity 620 is generally rectangular and has a central post 622, the cavity 620 may have different shapes in different embodiments (e.g., circular, polygonal, etc.) to accommodate a respective shape of the electric coil.

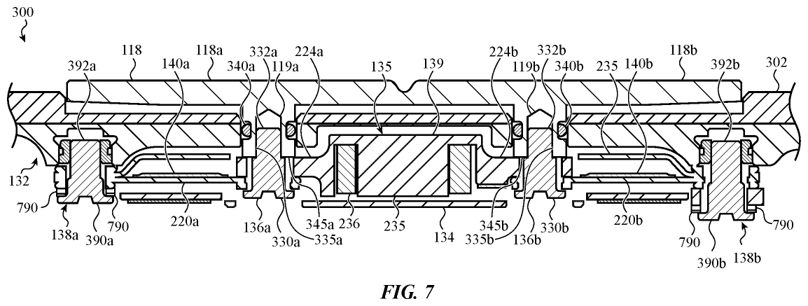

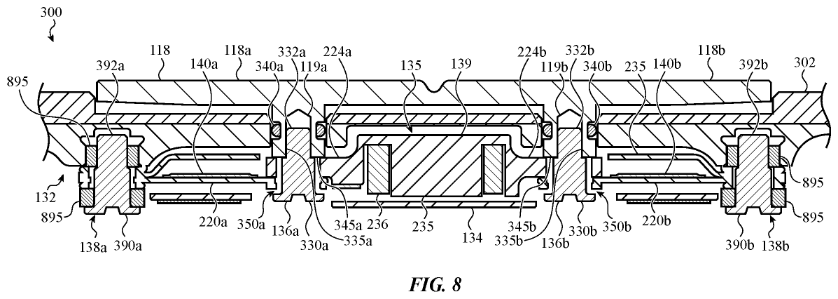

FIGS. 7 and 8 demonstrate ways to add cushioning between surfaces as the button 118 is pressed against the base 132, as shown in FIGS. 2-4B. FIG. 7 shows the example haptic module 300 described with reference to FIGS. 3A and 3B. The haptic module 300 may be attached to a device housing 302 using fasteners 138a, 138b. In contrast to what is shown in FIGS. 3A and 3B, respective pads 790 are disposed between the respective heads 390a, 390b of the fasteners 138a, 138b and the base 132. The pads 790 may provide a more compliant interface between the fasteners 138a, 138b and the base 132—especially when a user applies a force to the button 118, or when a haptic output is applied to the button 118, or during a device drop event. The pads 790 may also reduce friction between the base 132 and the fasteners 138a, 138b, and may reduce audible noise that might otherwise occur due to contact between these components. The pads 790 may be formed of or include a polymer material (e.g., nylon, polyethylene terephthalate (PET), polyimides), or any other suitable material that is softer or more compliant than the material of the base 132. The pads 790 may be adhered to or otherwise attached to the base 132 or the fasteners 138a, 138b using a pressure-sensitive adhesive. Alternatively, the pads 790 may disposed on the fasteners 138a, 138b like washers and be held in place by means of the fasteners 138a, 138b being fastened to the device housing 302.

FIG. 8 also shows the example haptic module 300 described with reference to FIGS. 3A and 3B. In contrast to what is shown in FIGS. 3A and 3B, the haptic module 300 may be attached to a device housing 302 using fasteners 138a, 138b and corresponding shear washers 895. The shear washers 895 may be positioned between the respective heads 390a, 390b of the fasteners 138a, 138b and the base 132 and/or between the base 132 and the device housing 302. The shear washers 895 may be formed of or include a polymer having sufficient stiffness that can withstand the bending stresses experienced by the fasteners 138a, 138b, such as low density polyethylene (LDPE), hard rubber, etc.

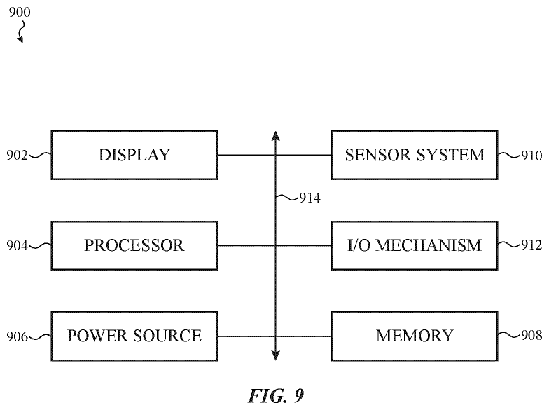

FIG. 9 shows an example electrical block diagram of an electronic device 900 having a haptic module, such as one of the haptic modules described herein. The electronic device 900 may take forms such as a hand-held or portable device (e.g., a smartphone, tablet computer, or electronic watch), a navigation system of a vehicle, and so on. The electronic device 900 may include an optional display 902 (e.g., a light-emitting display), a processor 904, a power source 906, a memory 908 or storage device, a sensor system 910, and an optional input/output (I/O) mechanism 912 (e.g., an input/output device and/or input/output port). The processor 904 may control some or all of the operations of the electronic device 900. The processor 904 may communicate, cither directly or indirectly, with substantially all of the components of the electronic device 900. For example, a system bus or other communication mechanism 914 may provide communication between the processor 904, the power source 906, the memory 908, the sensor system 910, and/or the input/output mechanism 912.

The processor 904 may be implemented as any electronic device capable of processing, receiving, or transmitting data or instructions. For example, the processor 904 may be a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

In some embodiments, the components of the electronic device 900 may be controlled by multiple processors. For example, select components of the electronic device 900 may be controlled by a first processor and other components of the electronic device 900 may be controlled by a second processor, where the first and second processors may or may not be in communication with each other.

The power source 906 may be implemented with any device capable of providing energy to the electronic device 900. For example, the power source 906 may include one or more disposable or rechargeable batteries. Additionally, or alternatively, the power source 906 may include a power connector or power cord that connects the electronic device 900 to another power source, such as a wall outlet, or a wireless charging circuit.

The memory 908 may store electronic data that may be used by the electronic device 900. For example, the memory 908 may store electrical data or content such as, for example, audio and video files, documents and applications, device settings and user preferences, timing signals, control signals, data structures or databases, image data, maps, or focus settings. The memory 908 may be configured as any type of memory. By way of example only, the memory 908 may be implemented as random access memory, read-only memory, Flash memory, removable memory, other types of storage elements, or combinations of such devices.

The electronic device 900 may also include one or more sensors defining the sensor system 910. The sensors may be positioned substantially anywhere on the electronic device 900. The sensor(s) may be configured to sense substantially any type of characteristic, such as but not limited to, touch, force, pressure, electromagnetic radiation (e.g., light), heat, movement, relative motion, biometric data, distance, and so on. For example, the sensor system 910 may include a touch sensor, a force sensor, a heat sensor, a position sensor, a light or optical sensor, an accelerometer, a pressure sensor (e.g., a pressure transducer), a gyroscope, a magnetometer, a health monitoring sensor, an image sensor, and so on. Additionally, the one or more sensors may utilize any suitable sensing technology, including, but not limited to, capacitive, ultrasonic, resistive, optical, ultrasound, piezoelectric, and thermal sensing technology.

The I/O mechanism 912 may transmit and/or receive data to/from a user or another electronic device. An I/O device may include a display, a touch sensing input surface such as a track pad, one or more buttons (e.g., a graphical user interface “home” button, one of the buttons described herein, or a crown), one or more cameras (including one or more image sensors), one or more microphones or speakers, one or more ports such as a microphone port, and/or a keyboard. Additionally or alternatively, an I/O device or port may transmit electronic signals via a communications network, such as a wireless and/or wired network connection. Examples of wireless and wired network connections include, but are not limited to, cellular, Wi-Fi, Bluetooth, IR, and Ethernet connections. The I/O mechanism 912 may also provide feedback (e.g., a haptic output) to a user.

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively.

Additionally, directional terminology, such as “top”, “bottom”, “upper”, “lower”, “front”, “back”, “over”, “under”, “above”, “below”, “left”, “right”, etc. is used with reference to the orientation of some of the components in some of the figures described below. Because components in various embodiments can be positioned in a number of different orientations, directional terminology is used for purposes of illustration only and is in no way limiting. The directional terminology is intended to be construed broadly, and therefore should not be interpreted to preclude components being oriented in different ways. These words are intended to relate to the equivalent direction as depicted in a reference illustration; as understood contextually from the object(s) or element(s) being referenced, such as from a commonly used position for the object(s) or element(s); or as otherwise described herein. Further, it is noted that the term “signal” means a waveform (e.g., electrical, optical, magnetic, mechanical, or electromagnetic) capable of traveling through a medium such as DC, AC, sinusoidal-wave, triangular-wave, square-wave, vibration, and the like.

Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

Although the disclosed embodiments have been illustrated and described with respect to one or more implementations, equivalent alterations and modifications will occur or be known to others skilled in the art upon the reading and understanding of this specification and the annexed drawings. In addition, while a particular feature is disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above-described embodiments. Rather, the scope of the disclosure should be defined in accordance with the following claims and their equivalents.

What is claimed is:

1. A device, comprising:
a button;
a base;
a haptic engine coupled to the base; and
a fastener fastening the button to the base, the fastener allowing movement of the button with respect to the base.

2. The device of claim 1, further comprising:
a device housing defining an opening; and
a shaft extending from the button, wherein,
the base, the haptic engine, and the fastener are positioned internal to the device housing;
the button is positioned external to the device housing; and
the shaft extends through the opening.

3. The device of claim 2, wherein:
the shaft defines a threaded hole and has an end facing a first surface of the base; and
the fastener is a shoulder screw extending through the base and into the threaded hole, the shoulder screw having,
a threaded shaft extending into the threaded hole;
a head facing a second surface of the base, the second surface opposite the first surface; and
a shoulder engaging the end of the shaft, the shoulder having a height sized to allow the movement of the button with respect to the base.

4. The device of claim 2, further comprising a second fastener fastening the base to the device housing.

5. The device of claim 4, wherein the second fastener is a screw having:
a head engaging a surface of the base; and
threads secured to the device housing.

6. The device of claim 5, further comprising a pad positioned between the head of the second fastener and the surface of the base, the pad having a first material composition that is softer than a second material composition of the base.

7. The device of claim 5, further comprising at least one shear washer positioned between the head of the second fastener and the surface of the base, or between the base and the device housing.

8. The device of claim 2, further comprising a compressible gasket surrounding the shaft.

9. The device of claim 8, wherein the compressible gasket is an O-ring.

10. The device of claim 1, further comprising:
a device housing defining a first opening and a second opening;
a first shaft extending from the button;
a second shaft extending from the button; and
a second fastener configured to fasten the button to the base, wherein,
the fastener is a first fastener;
the base, the haptic engine, the first fastener, and the second fastener are positioned internal to the device housing;
the button is positioned external to the device housing; and
the first shaft and the second shaft extend through the first opening and the second opening respectively, the first fastener and the second fastener attached to the first shaft and the second shaft respectively.

11. The device of claim 10, further comprising:
a third fastener fastening the base to the device housing; and
a fourth fastener fastening the base to the device housing.

12. The device of claim 10, further comprising:
a first O-ring surrounding the first shaft; and
a second O-ring surrounding the second shaft.

13. A device, comprising:
a frame;
an attraction plate coupled to the frame;
a core coupled to the frame and having,
a first stepped surface having portions abutting the frame, a first step of the first stepped surface having a rounded interior corner; and
a second stepped surface separated from the attraction plate by a gap, a second step of the second stepped surface having a square exterior corner; and
an electric coil wound around a portion of the core.

14. The device of claim 13, wherein the second stepped surface of the core defines a cavity and a post within the cavity, the electric coil wound around the post.

15. The device of claim 13, further comprising:
a button;
a first fastener coupled to the button; and
a second fastener coupled to the button; wherein,
the core further includes a first tab and a second tab extending in opposite directions, each of the first tab and the second tab having a respective aperture for receiving a respective one of the first fastener or the second fastener.

16. The device of claim 13, wherein the core comprises an alloy including iron, cobalt, and vanadium.

17. A device, comprising:
a frame comprising a tub, the tub having,
a bottom surface; and
a set of walls surrounding the bottom surface, each wall attached to the bottom surface and to two adjacent walls; and
a haptic engine, including,
an attraction plate coupled to the frame; and
a core disposed at least partially within the tub and separated from the attraction plate by a gap.

18. The device of claim 17, wherein:
the frame further includes,
a first flexure mount surface extending from a first wall of the set of walls; and
a second flexure mount surface extending from a second wall of the set of walls, the second wall opposite to the first wall; and
the device further includes,
a first flexure coupling the core to the first flexure mount surface; and
a second flexure coupling the core to the second flexure mount surface.

19. The device of claim 18, wherein the bottom surface of the tub defines an opening through which the core extends.

20. The device of claim 17, wherein the tub is a deep drawn tub.
